(19) United States
(12) Patent Application Publication
(10) Pub. No.: US 2024/0291548 A1
(43) Pub. Date: Aug. 29, 2024

(54) METHODS AND APPARATUS FOR BEAM MANAGEMENT

(71) Applicant: Telefonaktiebolaget LM Ericsson (publ), Stockholm (SE)

(72) Inventors: Athanasios KARAPANTELAKIS, Solna (SE); Konstantinos VANDIKAS, Solna (SE); Maxim TESLENKO, Sollentuna (SE); Alexandros NIKOU, Stockholm (SE); Aneta VULGARAKIS FELJAN, Stockholm (SE); Lackis ELEFTHERIADIS, Valbo (SE); Marin ORLIC, Bromma (SE); Marios DAOUTIS, Bromma (SE)

(21) Appl. No.: 18/571,462

(22) PCT Filed: Jul. 5, 2021
(86) PCT No.: PCT/EP2021/068519

§ 371 Date: Dec. 18, 2023

(51) Int. Cl. H04B 7/06; G06N 20/00; H04B 7/08

(52) U.S. Cl. CPC H04B 7/06964; G06N 20/00; H04B 7/088

(57) ABSTRACT

Methods and apparatus for beam management are provided. A computer-implemented method for beam management includes obtaining measurements of one or more properties of an environment, wherein the environment contains one or more User Equipments (UEs). The method further includes initiating transmission of the obtained property measurements to a machine learning (ML) agent hosting a ML model, and receiving the transmitted property measurements at the ML agent. The method also includes processing the received property measurements using the ML model to suggest one or more beam options for exchanging data with the one or more UEs, from among a plurality of beam options, and selecting, using the one or more suggested beam options, at least one of the one or more suggested beam options. The method additionally includes exchanging data with the one or more UEs using the selected beam options.

### TECHNICAL FIELD

Embodiments described herein relate to methods and apparatus for beam management, in particular for utilising Machine Learning (ML) to assist in the selection of beam options.

### BACKGROUND

3^{rd} Generation Partnership Project (3GPP) 5th Generation (5G) telecommunications networks may be configured to utilise beamforming. Beamforming allows nodes (including base stations such as 5G, next Generation Node Bs, gNBs) to establish directional transmission links towards other devices, for example, one or more User Equipments (UEs). The directional transmission links may be referred to as beams. FIG. 1A is a schematic diagram showing the beam output of a multiple input multiple output (MIMO) antenna array. The MIMO array shown in FIG. 1A includes 20 beams (numbered 1 to 20 in the figure) and provides coverage across an arc of 120°; accordingly, 3 such arrays could be used by a next Generation Node B (gNB) to provide 360° of coverage. The MIMO antenna array may be mechanical, or more frequently electronic, where multiple beams are realized using phase shifting.

The directional nature of the beams used in some 5G systems has the natural consequence that different beams may be more or less well suited to use in a connection between a node (such as a gNB) and a further device, such as a UE (for example). Further, 5G uses a much higher frequency spectrum than earlier 3GPP telecommunications networks such as 3rd Generation (3G) or 4th Generation (4G) networks. The 5G spectrum may be referred to as millimetre wave (mmWave), and typically comprises frequencies between 30 and 300 GHz. Use of higher frequencies provides improved data capacities, however higher frequencies are more susceptible to interference due to atmospheric conditions (such as moisture in the air), terrain topography, and so on. The higher frequencies used by 5G networks are therefore more difficult to propagate than the lower frequencies used by 3G and 4G networks. Therefore, a denser deployment of 5G radio base stations may be utilised in order to provide coverage for a given geographical area than would be used to provide coverage for the same geographical area using 4G base stations. Technologies such as integrated access and backhaul attempt to reduce the costs for installing and maintaining the additional 5G network infrastructure. A consequence of the above factors is a requirement to select a suitable beam or beams for transmissions between nodes and UEs (for example).

The term beam management may be used to refer to a collection of techniques used to select a suitable beam for establishing a connection between, for example, a UE and a gNB. The selection may be based on measurements for a number of candidate beams of reference signals, such as Channel State Information Reference Signals (CSI-RS). In particular, measurements of the Reference Signal Received Power (RSRP) from the UE and the subsequent selection of the beam with the highest value may be utilised.

An existing beam selection method is discussed in section 6.1.6.1 of “Technical Specification Group Radio Access Network; Study on New Radio Access Technology Physical Layer Aspects”, 3GPP TR 38.802 V 14.2.0, available at https://portal.3gpp.org/desktopmodules/Specifications/Specification Details.aspx?specificationld=3066 as of 7 Jun. 2021. An overview of an existing beam selection method is also shown in FIG. 1B. The method shown in FIG. 1B may comprise plural phases, up to three phases. In a first phase (P1), a base station (gNB) “sweeps” beams in a certain range (for example, 120 degrees as shown in FIG. 1A) with each beam used to transmit a Synchronization Signal Block-SSB, to select the best beam for a UE. The UE measures the power of received reference signals from all transmission (Tx) beams sent from gNB and reports to gNB the one that has the highest received power; this beam may be selected. In the example shown in FIG. 1B, beam 3 is selected. A further second phase (P2) may also be used, in which the base station (gNB) uses narrower beams to sweep a local area. The UE measures RSRP of CSI-RS from the narrower beams, and reports to the gNB the beam with the highest received power (highest RSRP); this beam may be selected. In the example shown in FIG. 1B, beam 3.2 is selected. A third phase (P3) may also be used, although this phase requires that the UE supports reception (Rx) beamforming in which the UE has the capability to produce adapted beams. In the third phase, given the beam selection of from P2, the UE refines its receiver beam using periodical transmission of a CSI-RS signal.

It is desirable to minimise the number of reference signal measurements used, as reducing the time used for reference signal measurements increases the time available for transmission of user and control-plane data. In existing beam selection methods, such as those shown in FIG. 1B, the base station may transmit a series of beams covering a certain range; for example, 5 beams are used to transmit in P1 of FIG. 1B. FIG. 1C is a schematic diagram of the transmission of SSBs, as used in P1 of FIG. 1B. As 5 beams are sent in P1, this step requires the transmission of 5 SSBs (one per beam) as shown in FIG. 1C, thereby requiring a significant amount of transmission time. Accordingly, the beam sweep process can result in a substantial delay in the sending of user and control-plane data between the base station and UE.

### SUMMARY

It is an object of the present disclosure to provide methods, apparatus and computer-readable media which at least partially address one or more of the challenges discussed above. In particular, it is an object of the present disclosure to support fast and power efficient beam management for 5G telecommunications networks.

The present disclosure provides methods and apparatus for beam management, in particular for implementing ML to allow fast and power efficient beam management.

An embodiment provides a computer-implemented method for beam management, the method comprising obtaining measurements of one or more properties of an environment, wherein the environment contains one or more UEs, and initiating transmission of the obtained property measurements to a ML agent hosting a ML model. The method further comprises receiving the transmitted property measurements at the ML agent, and processing the received property measurements using the ML model to suggest one or more beam options for exchanging data with the one or more UEs, from among a plurality of beam options. The method further comprises selecting, using the one or more suggested beam options, at least one of the one or more suggested beam options, and exchanging data with the one or more UEs using the selected beam options. By using the ML model to guide the selection of beams for us in data exchanges, the method may provide increased speed of beam selection and reduced numbers of reference signal transmissions relative to existing systems. The method may therefore increase the overall performance of a node (for example, a gNB with massive MIMO) as UEs attach faster to the network and/or start transmitting data faster. Also, use of beam selection utilising the ML model does not require as much power as a full sweep to detect optimal beams for UEs.

In some embodiments, the step of selecting at least one of the one or more suggested beam options may comprise sending first reference signals to at least one of the one or more UEs, and selecting at least one of the one or more suggested beam options based on the characteristics of the first reference signals received by at least one of the one or more UEs, wherein the first reference signals may be CSI-RS. By sending reference signals to least one of the one or more suggested beam options, the method may help ensure that the selection of beams for data exchange is optimal.

Some embodiments may further comprise training the ML model. While the ML model is being trained, a full sweep beam selection procedure may be used, until the ML model is trained. The initialisation parameters for the ML model may be obtained from a further ML model, wherein the further ML model has been trained in a further environment having similar properties to the properties of the environment. In this way, the ML model may be caused to converge on acceptable parameters faster than may be the case if the ML model is trained from randomised, generic initialisation parameters.

Where embodiments comprise training the ML model, the model may be trained using property measurements from the environment and information on the selected beam options, and/or using simulated property measurements obtained from a simulation of the environment. The training process may be adaptable to use various forms of training data.

Where embodiments comprise training the ML model, the model may be trained using RL. The RL may use a reward function dependent on a number of suggested beam options and a comparison of the suggested beam options and optimal beam options. RL may be particularly well suited for use in training the ML models in embodiments.

Embodiments may be used to control beam selection for a MIMO antenna array, potentially in a telecommunications network. Embodiments may particularly well suited to beam management in telecommunications network environments.

A further aspect of an embodiment provides a beam management module comprising processing circuitry and a memory containing instructions executable by the processing circuitry, whereby the beam management module is operable to obtain measurements of one or more properties of an environment, wherein the environment contains one or more UEs, and initiate transmission of the obtained property measurements to a ML agent hosting a ML model. The beam management module is further operable to receive the transmitted property measurements at the ML agent and process the received property measurements using the ML model to suggest one or more beam options for exchanging data with the one or more UEs, from among a plurality of beam options. The beam management module is further operable to select, using the one or more suggested beam options, at least one of the one or more suggested beam options, and exchange data with the one or more UEs using the selected beam options. The beam management module may provide one or more of the advantages discussed in the context of the corresponding method.

### BRIEF DESCRIPTION OF DRAWINGS

The present disclosure is described, by way of example only, with reference to the following figures, in which:

FIG. 1A is a schematic diagram showing the beam output of a multiple input multiple output (MIMO) antenna array;

FIG. 1B is an overview diagram of an existing beam selection method;

FIG. 1C is a schematic diagram of the transmission of SSBs;

FIG. 2A is a schematic illustration of a typical RL system;

FIG. 2B is an example of a beam output of a MIMO antenna array in accordance with an embodiment;

FIG. 3 is a flowchart of a method in accordance with embodiments;

FIG. 4A is schematic diagram of a beam management module in accordance with embodiments;

FIG. 4B is schematic diagram of a further beam management module in accordance with embodiments; and

FIG. 5A and FIG. 5B are a sequence diagram in accordance with an embodiment.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

Management of complex systems, such as telecommunications networks, is an ever-increasing challenge. In order to meet this challenge machine learning (ML) techniques such as reinforcement learning (RL) that enable effectiveness and adaptiveness may be implemented.

RL allows a Machine Learning System (MLS) to learn by attempting to maximise an expected cumulative reward for a series of actions utilising trial-and-error. RL agents (that is, a system which uses RL in order to improve performance in a given task over time) are typically closely linked to the system (environment) they are being used to model/control, and learn through experiences of performing actions that alter the state of the environment.

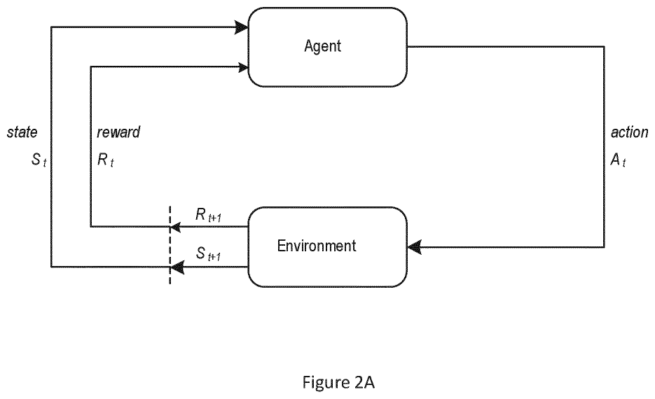

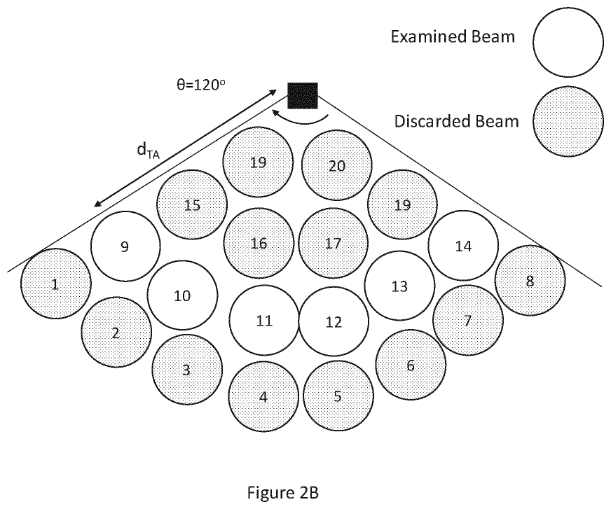

FIG. 2A illustrates schematically a typical RL system. In the architecture shown in FIG. 2A, an agent receives data from, and transmits actions to, the environment which it is being used to model/control. For a time t, the agent receives information on a current state of the environment Sₜ. The agent then processes the information Sₜ, and generates one or more actions to be taken; one of these actions is to be implemented Aₜ. The action Aₜ to be implemented is then transmitted back to the environment and put into effect. The result of the action Aₜ is a change in the state of the environment with time, so at time t+1 the state of environment is Sₜ₊₁. The action also results in a (numerical, typically scalar) reward Rₜ₊₁, which is a measure of effect of the action Aₜ resulting in environment state Sₜ₊₁. The changed state of the environment Sₜ₊₁ is then transmitted from the environment to the agent, along with the reward Rₜ₊₁. FIG. 2A shows reward Rₜ being sent to the agent together with state Sₜ; reward Rₜ is the reward resulting from action Aₜ₋₁, performed on state Sₜ₋₁. When the agent receives state information Sₜ₊₁ this information is then processed in conjunction with reward Rₜ₊₁ in order to determine the next action Aₜ₊₁, and so on. The action to be implemented is selected by the agent from actions available to the agent with the aim of maximising the cumulative reward. RL can provide a powerful solution for dealing with the problem of optimal decision making for agents interacting with uncertain environments.

According to embodiments ML systems, which may be RL systems, may be used for beam management. Use of ML systems in beam management may allow beam selection processes to be performed faster, thereby freeing up transmission time. Further, as the beam selection processes can be performed using fewer transmissions, embodiments may also reduce the power consumption of beam selection.

Embodiments may use a RL system, similar to the typical RL system shown in FIG. 2A. The environment may be all or part of a telecommunications network and may comprise one or more UEs (for example, mobile phones), and the state of the environment may be characterised using property measurements from the environment. The property measurements from the environment may vary between embodiments. Examples of property measurements may comprise measurements of the UEs in the environment, including the number of active UEs in the environment and/or the total number of UEs (active and inactive) in the environment. The property measurements may also include positioning information for some or all of the UEs in the environment; this positioning information may be obtained using a dedicated mechanism such as Global Navigation Satellite System (GNSS) measurements, however the position of UEs relative to an antenna may also be determined using timing advance (TA) measurements.

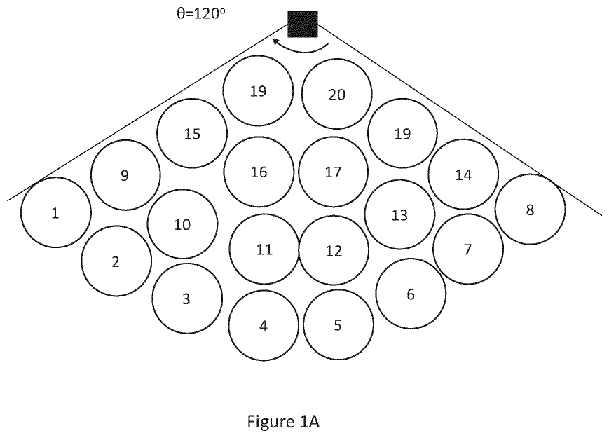

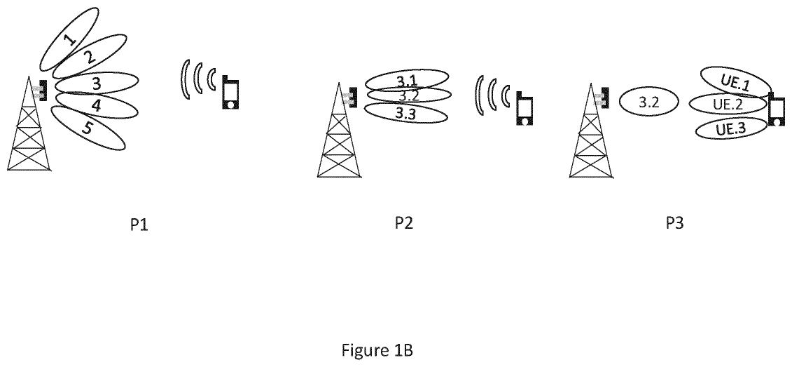

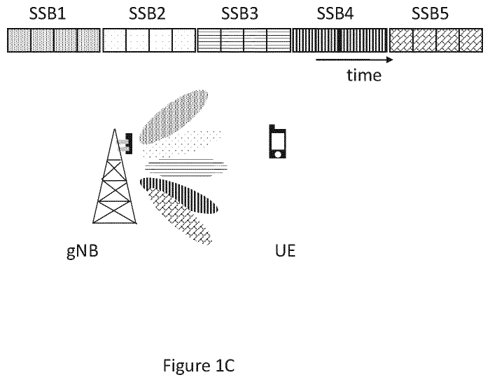

For example, TA measurements typically use the round-trip time (RTT) of data packets from the mobile phone to the antenna and back, commonly to ensure synchronization between uplink and downlink subframes at a base station. Based on physical properties of electromagnetic waves (for example, the known propagation speed through the atmosphere) and the RTT measurement contained in the TA, a distance between the UE and an antenna array that is part of the base station can be calculated. Beams output from an antenna array, such as a MIMO array, are typically directed towards the ground at a given distance away from the array (arrays are typically located high above the ground, for example, on towers or tall buildings). FIG. 2B shows an example of a beam output of a MIMO antenna array in accordance with an embodiment, similarly to FIG. 1A. The MIMO array shown in FIG. 2B includes 20 beams (numbered 1 to 20 in the figure) and provides coverage across an arc of 120°; again, this is as shown in FIG. 1A. Using TA measurements, the approximate distance between the antenna array and a given UE can be determined; this distance is shown as d_{TA} in FIG. 2B. The distance information can then be used to select beams which provide coverage at the correct distance from the antenna array, and other beams may be discarded from consideration when selecting a beam for transmissions with the UE. Returning to the example shown in FIG. 2B, the d_{TA} information indicates that (from among the 20 beams) beams 9 to 14 provide coverage at the correct distance from the MIMO array, therefore beams 1 to 8 and 15 to 20 can be discarded from consideration.

Other environment property measurements may include properties of the antenna, such as the current power load of the antenna array, performance measurements for antennas in the array (indicating whether or not the antennas are correctly functioning), and so on. More general information about the environment in which the antenna array and one or more UEs are located may also be included: the ambient temperature of the environment and the weather forecast and/or relative humidity may impact the transmission of signals and therefore may provide useful information, as may topological information for the environment (the 3 dimensional position of the antenna array, any natural or man-made bodies in the vicinity of the antenna array that may obstruct line-of-sight signals, and so on). The general information about the environment may also include information on predicted events in the environment if this information is available; events taking place in the vicinity of the base station (such as for example football matches, theatrical plays, demonstrations/protests, etc.) may affect UE numbers.

In order to provide useful suggestions, a ML model may be tailored for use in a given environment, so that the suggestions made take into account the characteristics of the environment; typically this tailoring takes the form of training the ML model. In some embodiments a ML model to be used may therefore be trained (for example, using RL) by a ML agent. Before training, the initialisation parameters of a ML model are typically set to generic values so that the ML model does not initially favour any particular action or actions over other actions, however in some embodiments the initialisation parameters may be set to non-generic values. In particular, the initialisation parameters for the ML model may be obtained from a further ML model that has already been trained in a further environment having similar properties to the environment in which the ML model to be trained will operate. Accordingly, in some embodiments the initialisation parameters of the ML model may be taken from a further ML model that has been trained for use in beam selection for a similar antenna, in a similar environment, for example. Obtaining initialisation parameters from a further ML model in this way may shorten the training process for the ML model, allowing the ML model to be trained to a sufficient degree to provide useful suggested actions in fewer rounds of training. Use of initialisation parameters from a further ML model may therefore reduce the computing burden (that is, the amount of processor time and memory used) to train the ML model. The choice of a further ML model should be similar to that of the ML model to be trained, for example, should relate to the same or similar type of antenna (having a similar number of beam options), the UE traffic profile (i.e., number of active UEs per time of day), the population and geographical characteristics of the area (i.e., urban/rural area), and so on.

In the training process, the training data for the ML model may be property measurements from the environment, in conjunction with information on the selected beam options. The ML model may be trained through ongoing observation of the environment; taking the example where RL is used to train the ML model, the ML model may receive a state of the environment and suggest one or more actions to be performed (that is, suggest a beam or beams that may be used). The suggestions from the ML model may then be evaluated using a reward function to generate a reward value, and the ML model may use this reward value to learn as discussed above. The reward function may be dependent on a number of suggested beam options (suggesting fewer beam options indicates that the ML model is more specific, scanning the suggested beam options would require less time than for a larger number of suggested beam options, and therefore may obtain higher reward values) and a comparison of the selected beam options and optimal beam options (the closer the suggested beam options are to the optimal beam options, the higher the reward value that may be obtained is). During the training process where the ML agent may not actually be influencing the choice of beam to use, the optimal beam option may be determined by evaluating all possible beams, for example, using one or more of the processes discussed above with reference to FIG. 1. Any suitable criteria may be utilised to evaluate the quality of the beams chosen and used in transmissions with one or more UEs, for example, one or more of: reference signal received power (RSRP); reference signal received quality (RSRQ); signal to interference and noise ratio (SINR); received signal strength indicator (RSSI); signal to noise plus interference ratio (SNIR); signal to noise ratio (SNR); received signal code power (RSCP), and so on. Where the one or more beams are used in transmissions with a plurality of UEs, the average values (mean, mode or median) of one or more of the criteria for all of the plurality of UEs may be used when evaluating the quality of the beam or beams chosen.

An example of the determination of the reward in accordance with an embodiment is as follows. For transmissions with a single UE and where the RSRP is used as the criteria for evaluating the beams, the RSRP at the UE on the suggested beam (RSRP_{suggested}) suggested by the ML model being trained is compared to the RSRP at the UE on the optimal beam (RSRPₒₚₜᵢₘₐₗ) from among the available beams (determined, as discussed above, by evaluating all possible beams). If the ML model suggested the optimal beam, these two values will be the same, otherwise RSRP_{suggested} will be less than RSRPₒₚₜᵢₘₐₗ. A further comparison between the number of beams in the set of suggested beams (BEAMS_{suggested}) and the total number of beam options (BEAMSₜₒₜₐₗ) may also be made. The reward value (R) may then be calculated using Equation 1, where a higher value indicates a better selection:

$$R = \frac{{RSRP}_{optimal}}{{RSRP}_{suggested}} - \frac{\vert {BEAMS}_{s uggested} \vert - 1}{\vert {BEAMS}_{total} \vert} \qquad Equation 1$$

In the above equation, RSRP values are given in decibel per milliwatt (dBm) and are negative values, such that an RSRP of −80 dBm is better than one of −140 dBm. Equation 1 is an example of a required function; any suitable reward function may be used depending on the configuration of a given embodiment. Other criteria that may also be taken into account in reward functions for some embodiments include weightings of the importance of different UEs (based on information provided by 5G network slices or by policy rules, for example).

In addition or alternatively to training the ML model using ongoing observations of beam selections and the environment, the ML model may be trained using simulated property measurements obtained from a simulation of the environment, and/or may be trained using stored property measurements (and beam selection information). Where RL is used in conjunction with stored property measurements, a reward function may be applied to the stored property measurements in order to determine the reward that would have been obtained, based on the suggested actions from the ML model being trained. The choice of the training data to be used may be made based on what data is available, the speed with which a trained ML model is required, and so on.

Using property information detailing the current state of the environment, a ML agent that has been trained may then suggest one or more actions that may be performed; here, the suggested actions may comprise a suggestion of beam options from among a plurality of available beam options.

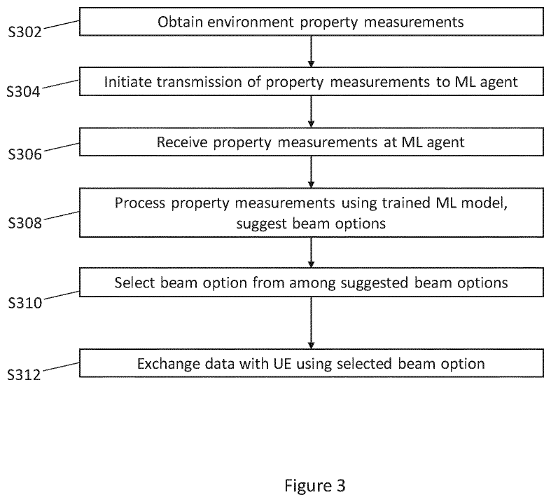

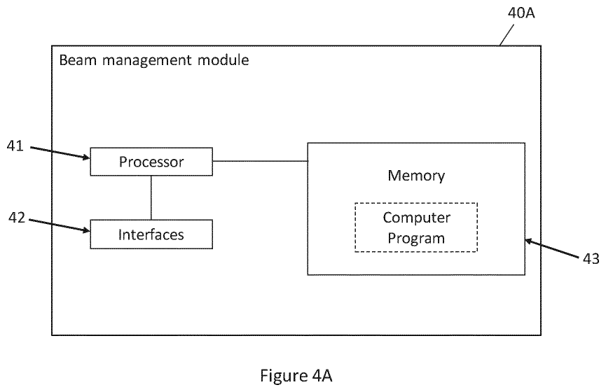

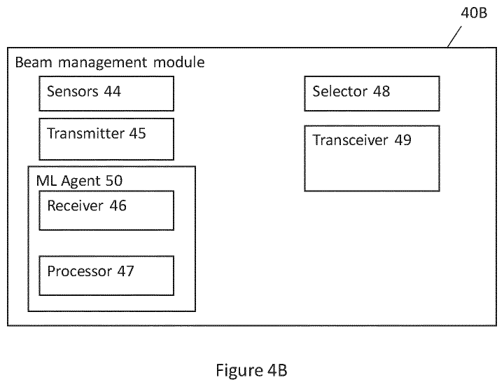

A method in accordance with embodiments is illustrated by FIG. 3, which is a flowchart showing a method for beam management. The computer-implemented method may be performed by any suitable apparatus, for example, by a beam management module 40A, 40B such as those shown in FIG. 4A and FIG. 4B. Where the environment is a telecommunications network (or part of the same), the method may be performed by an apparatus (such as a beam management module) that is or forms part of a base station or core network node (or may be incorporated in a base station or core network node). The telecommunications network may be a 5G network as discussed above, and the base station may be a gNB.

As shown in step S302 of FIG. 3 the method comprises obtaining environment property measurements; the environment property measurements may comprise some or all of the property measurements discussed above. In some embodiments, environment property measurements may be provided by a network component, such as a baseband unit (BBU), or by direct detection by a base station (or beam management module forming part of a base station); antenna array power load information is an example of an environment property that may be measured in this way. Other environment property measurements may be provided by other sources, for example, weather information may be provided by a third party weather monitoring/forecasting service. The step of obtaining the environment property measurements may be performed in accordance with a computer program stored in a memory 43, executed by a processor 41 in conjunction with one or more interfaces 42, as illustrated by FIG. 4A. Alternatively, the step of obtaining the environment property measurements may be performed by one or more sensors 44, potentially in conjunction with a receiver 46, as shown in FIG. 4B.

All of the environment property measurements may be transmitted to the ML agent in a suitable form, for example, as a vector of values that characterises the environment state. The step of initiating transmission of the obtained property measurements to the ML agent is shown in step S304 of FIG. 3, and the step of receiving the obtained property measurements at the ML agent is shown in step S306. The ML agent may be hosted within the same apparatus as the components obtaining the environment property measurements, in which case the transmission and reception of the environment property measurements may take place within that apparatus. Alternatively, the ML agent may be hosted elsewhere in a base station, or elsewhere in a telecommunications network (for example, in a core network node), in which case the transmission and reception of the obtained property measurements may be within the network node or within the telecommunications network. Any suitable wired or wireless transmission means may be used, depending on what is available in specific embodiments. The step of transmitting the obtained property measurements may be performed in accordance with a computer program stored in a memory 43, executed by a processor 41 in conjunction with one or more interfaces 42, as illustrated by FIG. 4A. Alternatively, the step of transmitting the obtained property measurements may be performed by the transmitter 45, as shown in FIG. 4B. Similarly, the step of receiving the obtained property measurements may be performed in accordance with a computer program stored in a memory 43, executed by a processor 41 in conjunction with one or more interfaces 42, as illustrated by FIG. 4A. Alternatively, the step of receiving the obtained property measurements may be performed by the receiver 46 of the ML agent 50, as shown in FIG. 4B. In the embodiments shown in FIG. 4A and FIG. 4B, the ML agent is located within the same module (the beam management module) as the components responsible for obtaining environment property measurements; as explained above this is not necessarily the case for all embodiments.

When the obtained property measurements have been received by the ML agent, the ML model (which has been trained) is then used to process the received property measurements to suggest one or more beam options from among the plurality of beam options for use in exchanging data with the one or more UEs, as shown in step S308 of FIG. 3. The step of processing the property measurements may be performed in accordance with a computer program stored in a memory 43, executed by a processor 41 in conjunction with one or more interfaces 42, as illustrated by FIG. 4A. Alternatively, the step of processing the property measurements may be performed by the processor 47 of the ML agent 50, as shown in FIG. 4B. The property measurements are input into the ML model in any suitable format, for example as a vector of values characterising the state of the environment. The ML model then processes the property measurements an suggests one or more beam options from among the plurality of beam options. The suggested beam options may comprise any number of beams from 1 to all of the plurality of beam options (although typically the number of suggested beam options is substantially fewer than all of the plurality of beam options). Accordingly, if the total number of beam options (all of the plurality of beam options) for a given system is n, then the size of the action space is 2ⁿ−1. For the MIMO antenna shown in FIG. 1A, the total number of beams is 20, so the size of the action space is 2²⁰−1, that is, 1048575.

When the ML model has suggested one or more beam options from the plurality of beam options, the method then comprises selecting at least one (and potentially all) of the suggested beam options, as shown in step S310 of FIG. 3. The selection may be made based on the output from the ML model, for example, the suggested beam options from the ML model may be ranked in order of likely successful transmission, or provided with indications of which of the options is favoured by the ML model. In some embodiments, all of the suggested beam options may be used without further discrimination between beam options.

In some embodiments, the step of selecting at least one of the one or more suggested beam options comprises sending reference signals to at least one of the one or more UEs, and selecting at least one of the one or more suggested beam options based on the characteristics of the reference signals received by at least one of the one or more UEs. The reference signals may be any suitable reference signals, for example, CSI-RS as discussed above. Further, the characteristics of the reference signals used to select from among the suggested beams may be any suitable characteristics; examples include one or more of: reference signal received power (RSRP); reference signal received quality (RSRQ); signal to interference and noise ratio (SINR); received signal strength indicator (RSSI); signal to noise plus interference ratio (SNIR); signal to noise ratio (SNR); received signal code power (RSCP), and so on. Where reference signals are used in this way, the selection from among the suggested beam options is similar to the P1 selection process shown in FIG. 1B, save that as the selection is from among the suggested beam options rather than all of the plurality of beam options, the number of reference signals sent and analysed is typically significantly smaller than in the P1 selection process discussed above. The additional selection steps shown in steps P2 and P3 of FIG. 1B may also be performed in some embodiments. The step of selecting at least one of the suggested beam options may be performed in accordance with a computer program stored in a memory 43, executed by a processor 41 in conjunction with one or more interfaces 42, as illustrated by FIG. 4A. Alternatively, the step of selecting at least one of the suggested beam options may be performed by the selector 48, as shown in FIG. 4B.

Once a selection has been made using the one or more suggested beam options, the method then comprises exchanging data with the one or more UEs, using the selected beam options, as shown in step S312 of FIG. 3. The step of selecting at least one of the suggested beam options may be performed in accordance with a computer program stored in a memory 43, executed by a processor 41 in conjunction with one or more interfaces 42, as illustrated by FIG. 4A. Alternatively, the step of selecting at least one of the suggested beam options may be performed by the selector 48, as shown in FIG. 4B. Where the environment is a telecommunications network (or part of the same), the exchange of data may be performed by a base station that is the beam management module, or that the beam management module forms part of. Alternatively, where a beam management module is or forms part of another network component such as a core network node, the exchange of data with the UE may be performed by a separate apparatus within the network as instructed by the beam management module.

In some embodiments the method may further comprise a step of sending reference signals after the exchange of data with the one or more UEs. The further reference signals, which may be sent subsequent to the step of exchanging data with the one or more UEs may be sent using some or all of the plurality of beam options, and may utilise one or more of the P1, P2 and P3 steps as set out in FIG. 1B. The further reference signals that are sent subsequent to the step of exchanging data with the one or more UEs may be sent in addition or alternatively to the reference signals that may be sent to at least one of the one or more UEs in the step of selecting at least one of the one or more suggested beam options. In some embodiments, the use of further reference signals using some or all of the plurality of beam option may be interspersed with selections made using the ML agent; in this way the total number of reference signals used is reduced while still allowing the performance of the ML agent to be monitored. The number of further reference signals sent may be varied if variations in the environment are expected based on, for example, weather conditions or anticipated increases in the number of active UEs (due to a sporting event, for example). In some embodiments, a regular pattern of beam selection according to reference signal use and beam selection according to ML model suggestion use may be implemented, for example, alternating between reference signal use and ML model suggestion use.

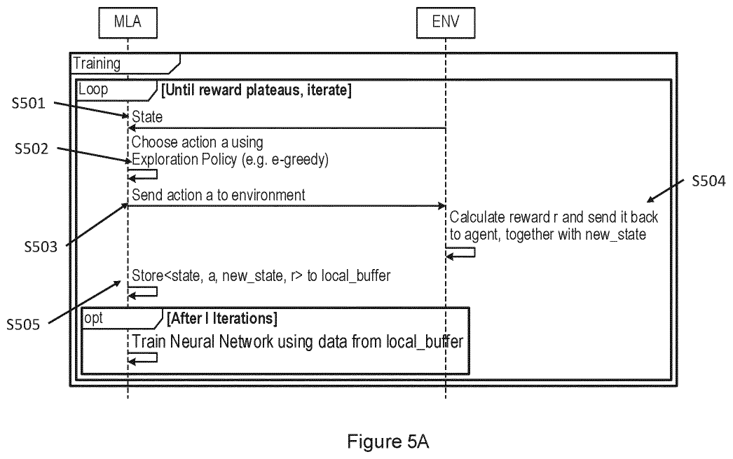

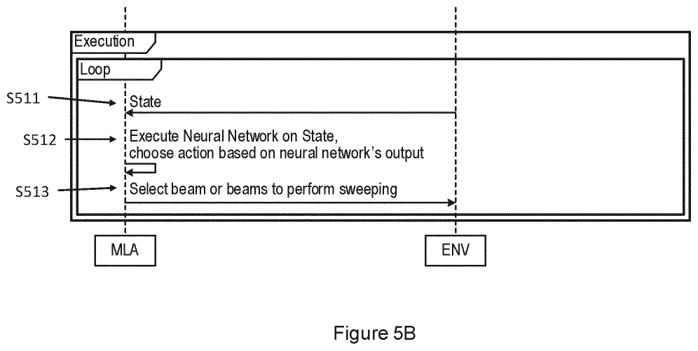

FIG. 5A and FIG. 5B (collectively FIG. 5) are a sequence diagram showing processes in accordance with an embodiment. The sequence diagram is divided into two phases; FIG. 5A shows a training phase and FIG. 5B shows an execution phase. In the embodiment shown in FIG. 5, the ML model is a neural network. The ML model is hosted in the ML Agent (MLA in FIG. 5). Aₜ the start of the training, the ML model uses either generic parameters or receives initiation parameters from a further ML model as discussed above. As indicated in the training phase, the training of the ML model may continue until a training cessation condition is arrived at; any suitable training cessation condition may be used, such as the reward reaching a certain level or having a variation below a certain amount over a certain number of rounds of training (that is, the reward plateauing, as shown in FIG. 5A). If the reward plateaus, this means that the agent has reached its full potential. If the reward reaches a certain value, this means that the agent has become acceptably “good” at making good beam selections for the given embodiment.

While the training is ongoing, the ML agent obtains property measurements from the environment (ENV), as shown in S501. The ML agent then processes the property measurements using the ML model to generate a suggested action (see S502) which is then sent to the environment (see S503). The reward for the action and the new state of the environment are then determined and sent to the ML agent (see S504), which then stores the reward and state of the environment (see S505) and then repeats this process. In the embodiment to which FIG. 5 relates the ML model is trained using ongoing observation of the environment; as explained above in alternative embodiments a ML model may be trained using stored data, simulation data, and so on (as indicated by the optional feature shown in FIG. 5A).

Once the training cessation condition is satisfied the training is complete. The execution phase then begins, and the trained ML model is used to suggest beam options as discussed above (see FIG. 5B). Property measurements indicating the state of the environment are received by the ML agent (see step S511), processed using the ML model to generate one or more suggested beams (see S512), and then selected beams are sent back to the environment (see S513).

Embodiments may be utilised, for example, to increase the speed and/or reduce the number of reference signals used for beam management. Accordingly, embodiments may save processing resources, and may also make more transmission time available for user data and so on. Antenna power may also be conserved. Embodiments may therefore increase the speed and efficiency of beam management relative to existing systems.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some embodiments may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A computer-implemented method for beam management, the method comprising:
obtaining measurements of one or more properties of an environment, wherein the environment contains one or more User Equipments, UEs;
initiating transmission of the obtained property measurements to a machine learning, ML, agent hosting a ML model;
receiving the transmitted property measurements at the ML agent;
processing the received property measurements using the ML model to suggest one or more beam options for exchanging data with the one or more UEs, from among a plurality of beam options;
selecting, using the one or more suggested beam options, at least one of the one or more suggested beam options; and
exchanging data with the one or more UEs using the selected beam options.

2. The method of claim 1, wherein the step of selecting at least one of the one or more suggested beam options comprises:
sending first reference signals to at least one of the one or more UEs; and
selecting at least one of the one or more suggested beam options based on the characteristics of the first reference signals received by at least one of the one or more UEs.

3. The method of claim 2, wherein the first reference signals are Channel State Information Reference Signals, CSI-RS.

4. The method of claim 2, wherein the characteristics of the first reference signals received by at least one of the one or more UEs comprise at least one of:
reference signal received power, RSRP;
reference signal received quality, RSRQ;
signal to interference and noise ratio, SINR;
received signal strength indicator, RSSI;
signal to noise plus interference ratio, SNIR;
signal to noise ratio, SNR;
received signal code power, RSCP.

5. The method of claim 1, further comprising, subsequent to the step of exchanging data with the one or more UEs:
sending second reference signals to at least one of the one or more UEs; and
selecting at least one of the plurality of beam options based on the characteristics of the second reference signals received by the at least one of the one or more UEs.

6. The method of any claim 1 further comprising training the ML model.

7. The method of claim 6, wherein initialisation parameters for the ML model are obtained from a further ML model, and wherein the further ML model has been trained in a further environment having similar properties to the properties of the environment.

8. The method of claim 6, wherein the ML model is trained using property measurements from the environment and information on the selected beam options.

9. The method of claim 6 wherein the ML model is trained using simulated property measurements obtained from a simulation of the environment.

10. The method of claim 6, wherein the ML model is trained using Reinforcement Learning, RL.

11. The method of claim 10, wherein the RL uses a reward function dependent on a number of suggested beam options and a comparison of the suggested beam options and optimal beam options.

12. The method of claim 11, wherein the ML model is trained using stored property measurements, wherein the reward function is applied to the stored property measurements.

13. The method of claim 1, wherein method is used to control beam selection for a Multiple Input Multiple Output, MIMO, antenna array.

14. The method of claim 13, wherein the properties of the environment comprise one or more of:
a number of active UEs in the environment;
a total number of UEs in the environment;
UE positioning information;
a current power load of the antenna array;
an ambient temperature in the environment;
a current time and date;
climate information for the vicinity of the environment;
topological information for the environment; and
predicted events in the environment.

15. The method of claim 13, wherein the method is performed by a component in a telecommunications network, the telecommunications network comprising the MIMO antenna array.

16. The method of claim 13, wherein the environment comprises at least a part of a telecommunications network.

17. A beam management module comprising processing circuitry and a memory containing instructions executable by the processing circuitry, whereby the beam management module is operable to:
obtain measurements of one or more properties of an environment, wherein the environment contains one or more User Equipments, UEs;
initiate transmission of the obtained property measurements to a machine learning, ML, agent hosting a ML model;
receive the transmitted property measurements at the ML agent;
process the received property measurements using the ML model to suggest one or more beam options for exchanging data with the one or more UEs, from among a plurality of beam options;
select, using the one or more suggested beam options, at least one of the one or more suggested beam options; and
exchange data with the one or more UEs using the selected beam options.

18. The beam management module of claim 17 further configured, when selecting at least one of the one or more suggested beam options to:
send first reference signals to at least one of the one or more UEs; and
select at least one of the one or more suggested beam options based on the characteristics of the first reference signals received by at least one of the one or more UEs.

19. (canceled)

20. (canceled)

21. The beam management module of claim 17 further configured, subsequent to the step of exchanging data with the one or more UEs, to:
send second reference signals to at least one of the one or more UEs; and
select at least one of the plurality of beam options based on the characteristics of the second reference signals received by the at least one of the one or more UEs.

22. (canceled)

23. The beam management module of claim 17, configured to obtain the initialisation parameters for the ML model from a further ML model, wherein the further ML model has been trained in a further environment having similar properties to the properties of the environment.

24. The beam management module of claim 17, configured to train the ML model using property measurements from the environment and information on the selected beam options.

25. The beam management module of claim 17 configured to train the ML model using simulated property measurements obtained from a simulation of the environment.

26. The beam management module of claim 17, configured to train the ML model using Reinforcement Learning, RL.

27. The beam management module of claim 26, configured to use a reward function in the RL that is dependant on a number of suggested beam options and a comparison of the suggested beam options and optimal beam options.

28. The beam management module of claim 27, configured to train the ML model using stored property measurements, and to apply the reward function to the stored property measurements.

29. The beam management module of claim 17, wherein the module is configured to control beam selection for a Multiple Input Multiple Output, MIMO, antenna array.

30-34. (canceled)
